(19) United States
(12) Patent Application Publication
(10) Pub. No.: US 2012/0245914 A1
(43) Pub. Date: Sep. 27, 2012

(54) HOLLOW NEEDLE POSITIONING SYSTEM

(75) Inventor: Alberto Fernandez Dell Oca, Montevideo (UY)

(73) Assignee: SIEMENS AKTIENGESELLSCHAFT, MUENCHEN (DE)

(21) Appl. No.: 13/502,808

(22) PCT Filed: Oct. 18, 2010
(86) PCT No.: PCT/EP2010/065625

§ 371 Date: Jun. 13, 2012

Related U.S. Application Data
(60) Provisional application No. 61/252,764, filed on Oct. 19, 2009.

(51) Int. Cl. G06G 7/60

(52) U.S. Cl. 703/11

(57) ABSTRACT

A method for determining a relative position of an hollow needle with a wire partially held by the hollow needle and a bone of a creature includes the following steps: i) capturing into a computer an X-ray image of the hollow needle inserted into a bone region; where the X-ray image has at least an image of the real bone, the hollow needle and the wire inserted in the hollow needle; ii) opening a 3D virtual model of the bone region, where the bone region has a virtual bone model, a virtual hollow needle and a virtual wire; iii) assessing a 3D virtual exact position of the needle relative to the bone region by freely moving, rotating and zooming the 3D virtual objects. The process does not require additional bulky equipment that must be held and maintained in the operating room.

The present application hereby claims the priority of the U.S. provisional application No. US 61/252,764 filed Oct. 19, 2009. This application is hereby incorporated by reference.

The present invention relates to a method for hollow needle positioning with an image workflow according to the preamble of claim 1.

To precisely insert a needle in a bone region either to perform a biopsy, to fix a fracture, or to fill with cement a void at a bone is a frequently required task for either a bone surgeon or a radiologist.

As a guide for the needle placement in a creature, two planar conventional X-ray or CAT scan are generally used. For the assessment of the relative pose of an invasive object like a needle and a bone of a creature usually X-ray images are used, in particular in a surgery environment when bone fragments have to be fixed in the correct pose. Usually, so-called C-arm systems are used which combine an X-ray source and an X-ray detector on a mobile cart having the form of the letter “C” allowing to rotate the X-ray source in the range of about 180° around a human patient or an animal. Nevertheless, since the C-arm device is mobile device, the image information contributes to a first control of what has been done by the surgeon but lacks precise information.

Systems for needle positioning are known. According to WO 2006/125605 A1 [2] a needle positioning system comprises a device which is used to position instruments within an examination chamber, wherein an access area and the relative orientation of the instrument, which is used to reach the target area, marks the oriented electro-magnetic radiation or a supply element, said target area lying in a path. Further a method based on a computer program is disclosed. The method is used to position positioning device for an interventional instrument within the examination chamber, and instruments which are used in said method and a computer program which is used to control a positioning device.

The document DE 10 200 600 47 03 A1 [1] describes a method which evaluates three dimensional image data of the object with the positioning robot. The robot is pre-positioned relative to the object and then determining from this a registration of a coordinate system of the object and a coordinate system of the robot. By taking into account the already known limits for the movements which can be executed by the robot it is then determined which areas the hollow needle can reach in the object into which it is to be inserted and/or where the straight line can run along which it is to be introduced.

It is hard for a radiology department to achieve the sterile environment which is required to perform a surgical procedure, and the CAT scan machines for use at the operating room are bulky, heavy and expensive in respect to conventional X-ray C-arms.

For the assessment of the relative pose of an object and a bone of a creature usually X-ray images are used, in particular in a surgery environment when bone fragments have to be fixed in the correct pose. Usually, so-called C-arm systems are used which combine an X-ray source and a X-ray detector, e.g. an image intensifier on a mobile cart having the form of the letter “C” allowing to rotate the X-ray source in the range of about 180° around a human patient or an animal. Nevertheless, since the C-arm device is a mobile device, the image information contributes to a first control of what has been done by the surgeon but lacks precise information about acquisition geometry.

With the availability of X-ray computer tomography imaging (CT) and, of course, other image generating devices, like ultra-sound or magnetic resonance imaging MRI, the possible shortcomings of the 2D C-arm information can be mitigated by post-operative CT scans for a precise assessment of the surgery results. Unfortunately, this means that patients have to undertake a re-surgery in order to reposition a bone fragment and/or the respective object in case of mal-alignment or misplacement of the object. This problem has been addressed by the design of mobile C-arms with 3D scan capabilities. But these mobile 3D devices have the limitations according to measurement time and radiation dose considerations. Therefore, a real demand exists for providing 3D information in 2D X-ray images in the operation room.

Diverse solutions exist. WO 2009/027088 A1 [3] teaches a method of determining spatial cue information for an object in a spatial environment on the basis of two dimensional image information of the object for augmented two dimensional visualization of the object.

U.S. Pat. No. 7,489,810 [4] discloses a method and a system for linking position (pose) information between two-dimensional 2D and three-dimensional 3D software applications for viewing diagnostic medical images. The position location information is integrated between 2D and 3D viewing paradigms. This integration provides directional communication between the 2D and 3D viewing paradigm systems. The 3D cursor allows for immediate synchronized navigation through different image sets such 3D magnetic resonance images and 2D images while they are being simultaneously viewed on the two different viewing applications.

So there is a need for a better image guidance method. It is therefore an objective of the present invention to provide a method for a hollow needle and wire positioning and image workflow for determining the relative pose of an object and a bone of a creature already in the operation room which don't required any additional bulky equipment that has to be held and maintained in the operation room.

This objective is achieved according to the present invention by the method for positioning the relative pose of an hollow needle with a wire partially hold by the hollow needle and a bone of a creature defined by the steps specified in claim 1.

Preferred embodiments of the present invention provide the method and the system having specific implementations of the method steps and the system components as mentioned above, wherein one or more of the following feature can be applied:

### Use of a K-wire;

use of a K-wire with a scale allowing a determination of the geometry of the virtual objects.

Preferred embodiments of the present invention are hereinafter explained in more detail with reference to the attached drawings.

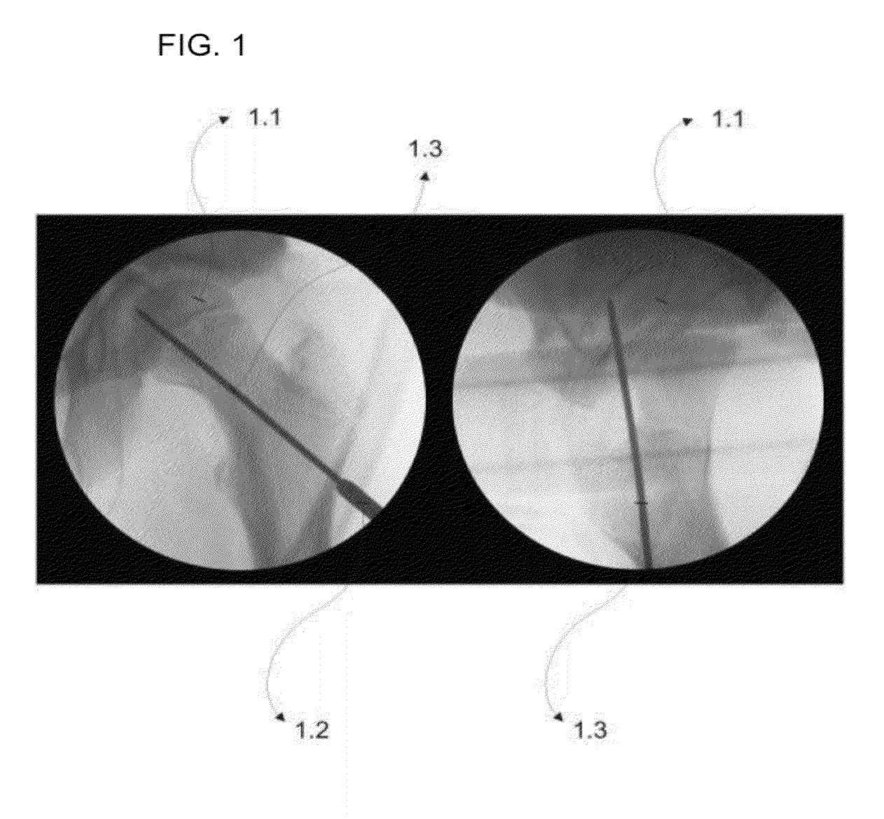

FIG. 1

Snap shot obtained at the Operation Room using the X ray C arm after a needle was inserted in two views;

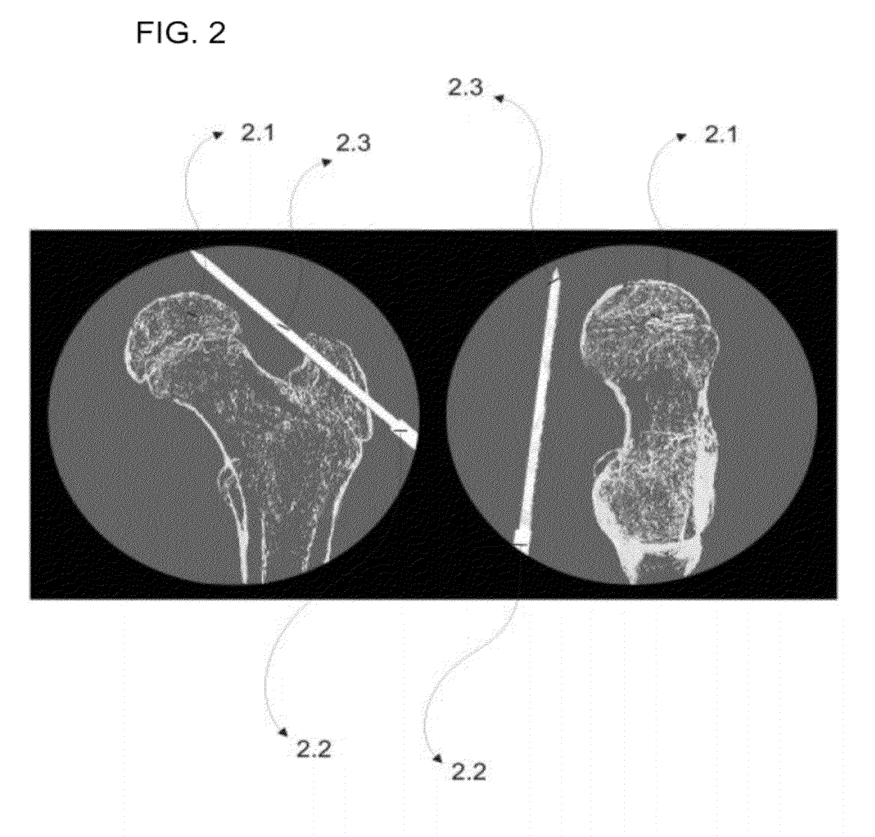

FIG. 2

virtual bone model of the bone region and hollow needle of FIG. 1 in two views;

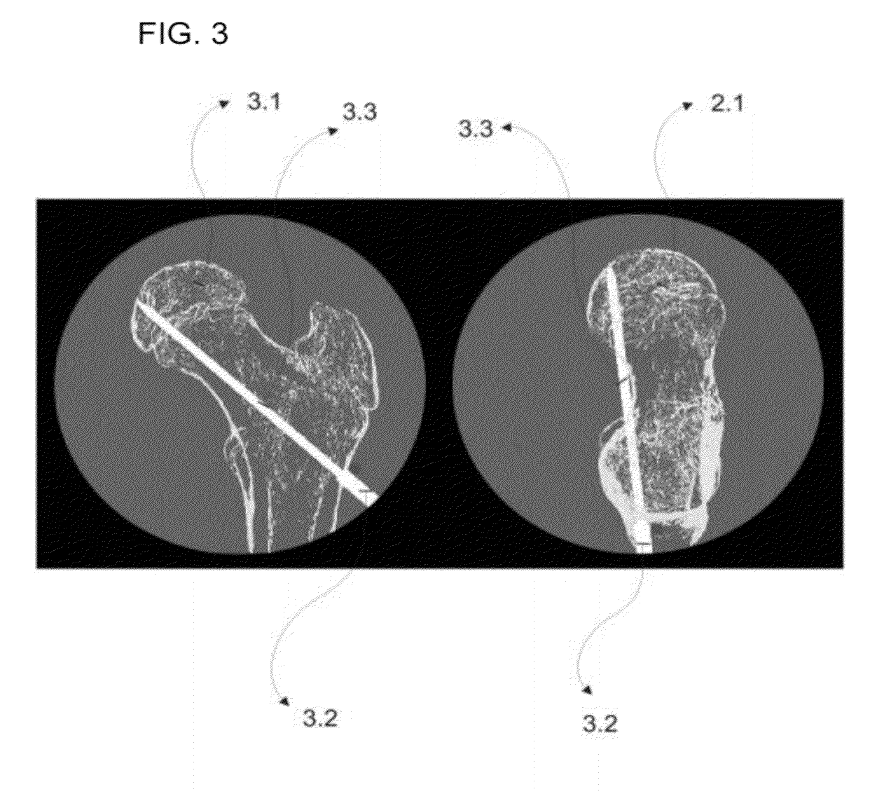

FIG. 3

3D virtual bone model and 3D virtual hollow needle positioned as to reproduce the X ray image in two views;

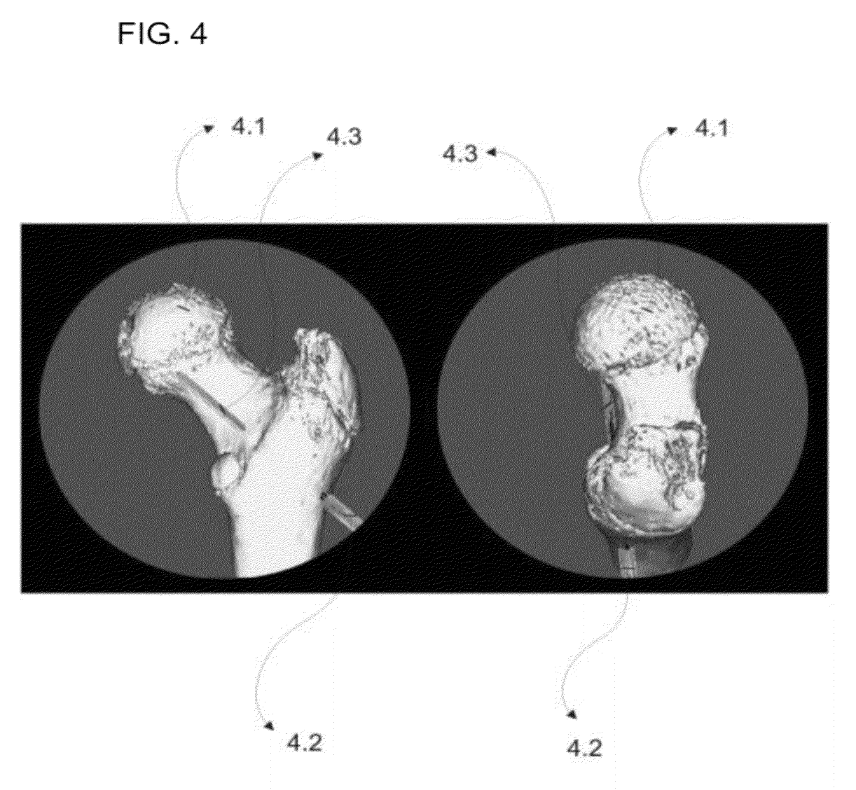

FIG. 4

solid view of model of FIG. 3 in two views;

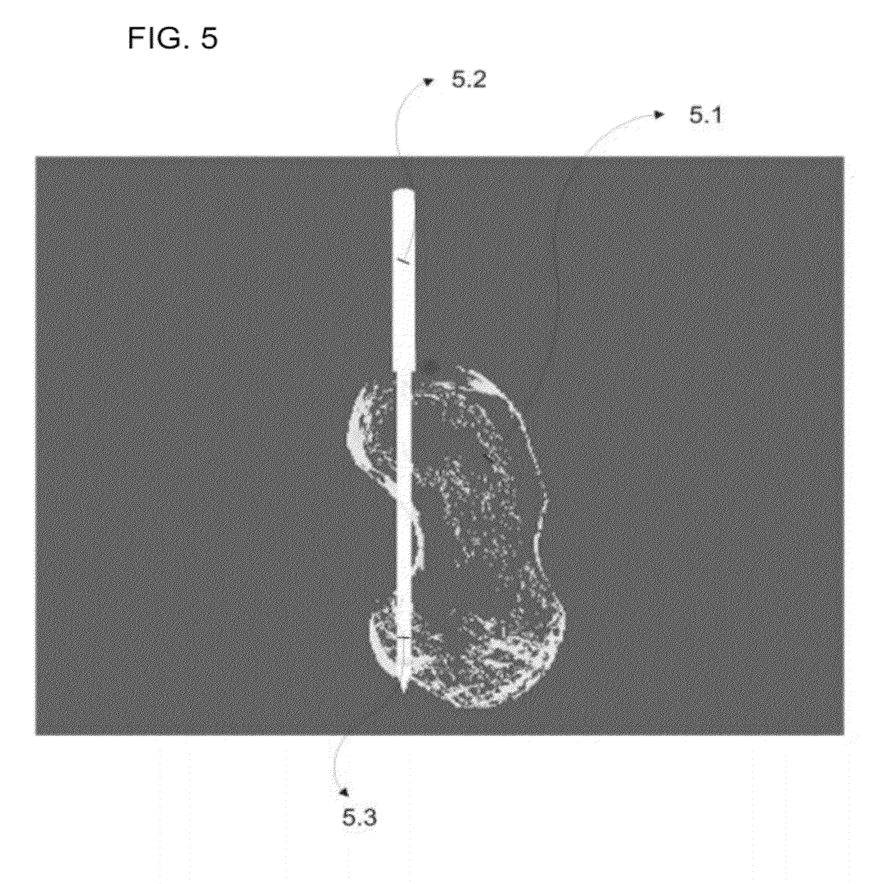

FIG. 5

cut view of model of FIG. 3;

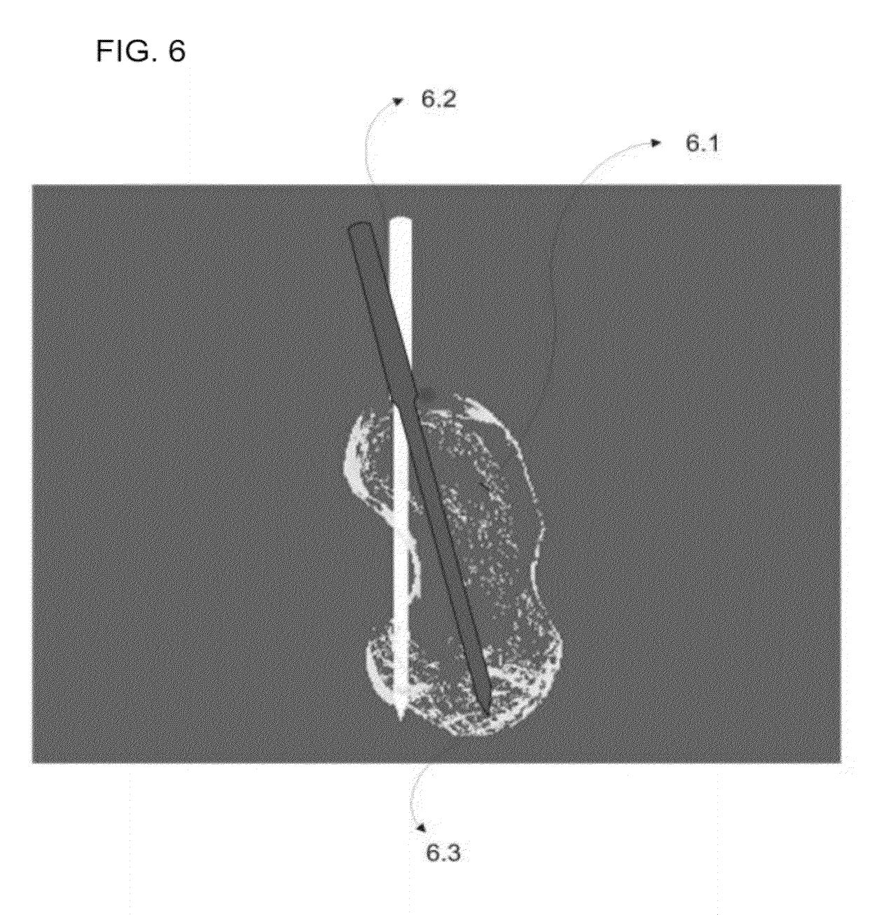

FIG. 6

second virtual hollow needle in the ideal position in cut view

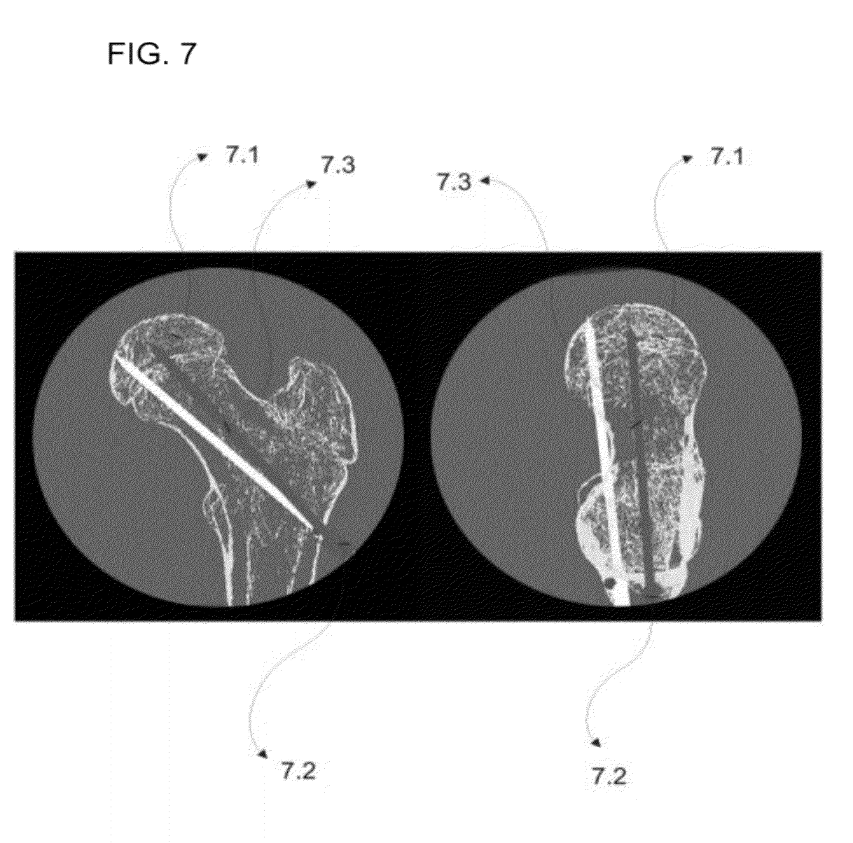

FIG. 7

simulated X ray view of the virtual needles in two views;

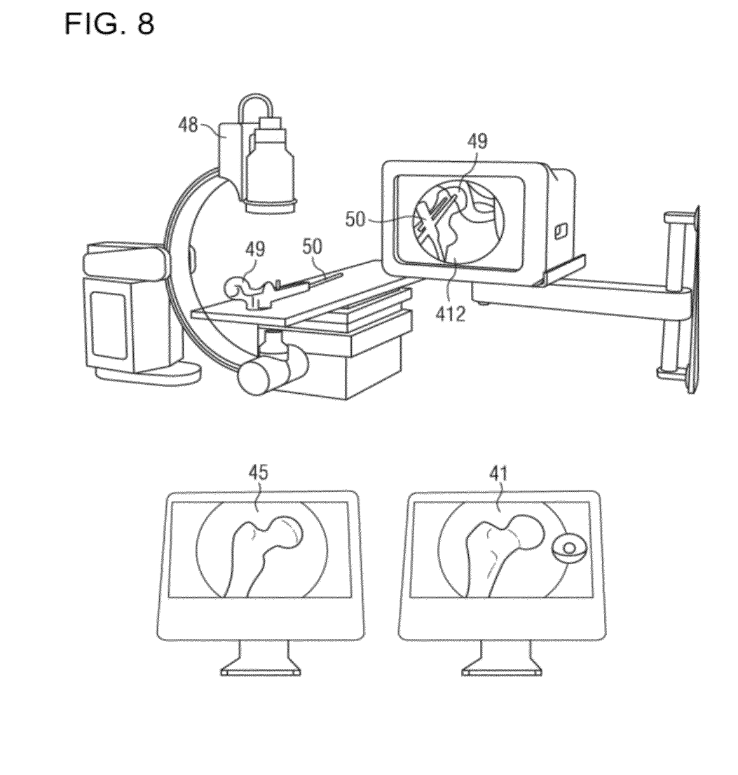

FIG. 8

typical operation room environment.

FIG. 8 represents schematically a typical operation room environment. A C-arm system 48 is imaging a C-arm image 412 of a real bone 49 and an implant 50. In the workflow, the image 412 is reproduced as an image 45 in reproduced simulated radiation mode. A virtual image 41 shows a virtual bone having the same pose as the real bone shown the reproduced image 45.

A preferred embodiment of the present invention of a method for hollow needle positioning and image an workflow comprises the following steps:

Step i)

Capturing into the computer the X ray image of a hollow needle inserted into a bone region, through the use of a C arm at the operating room. The X-ray image comprises the images of

real bone 1.1;

hollow needle 1.2 and

wire 1.3 inserted inside of the hollow needle 1.2. A concrete X-ray image is depicted in FIG. 1.

Step ii)

Opening of a 3D virtual model of the bone region in which an operation will take place. The 3D virtual model comprises
a virtual bone model 2.1;
a virtual hollow needle 2.2 and
a virtual wire 2.3. A 3D virtual model is depicted in FIG. 2. The virtual wire 2.3 corresponds to a K-wire. K-wires are wires or pins which are basically sterilized, sharpened, smooth stainless steel pins. The <<K>> derives from Mr. Martin Kirschner who introduced this device for use in orthopedics and other types of medical and veterinary surgery.

Step iii)

Opening of the 3D virtual model of the actually used hollow needle.

Step iv)

By freely moving, rotating and zooming the said 3D virtual objects (virtual base model, virtual hollow needle) the said X-ray image is reproduced at the computer screen. Now the 3D real exact position of the said needle respect to the said bone region can be exactly assessed, by either solid 3D view or cut view. FIG. 3 depicts in two views
a virtual bone model 3.1;
a virtual hollow needle 3.2 and
a virtual wire 3.3.
The adaption of the models to the images takes place with a 2D/3D registration which comprises a calculation of 2D projections of the 3D models until they fit to the 2D X-ray image. The conditions are:
a) The geometry of the X-ray image must be known;
b) The models must be structured in order to be visible in details also in the X-ray image. For that purpose the objects as e.g. a K-wire must carry additional structures. Example for such an additional structure
specific X-ray markers,
recesses, holes, and/or indents in defined distances. Without such markers as cited before it is nearly impossible to identify circular (radial symmetric) objects regarding their relative position and orientation. It is a subtask to determine the absolute length of the K-wire outside the needle. This subtask is solved by the following described solutions.

Solution 1
For a 3D-position and orientation determination of a K-wire via the above cited 2D/3D registration the length of the K-wire must be known. For that purpose a scale is mounted on the K-wire. The technique for mounting a scale comprises e.g. recesses or indents on the surface of the hollow needle beginning from the proximal end of the K-wire. The recesses and/or indents are in equidistant intervals. The length of the hollow needle is known. In a calibration step the K-wire is put into the hollow needle until its end. The corresponding marker/value on the scale of the K-wire represents the new virtual zero point. By moving the K-wire from this position through the hollow needle the length of the part of the K-wire not being in the needle can be determined.

Solution 2
There is a need to visualize the pinpoint of the K-wire as well as also the distal end of the K-wire, which sticks out from the hollow needle. This is a condition for determining said length. In case the pinpoint or the distal end not visible, it will not be possible to determine directly the length. This situation could be avoided by at least two markers on the K-Wire where the two markers are visible on the X-ray image. Additionally the distance between these two markers must be known. The markers can be formed by indents or recesses or be the inclusion of a material with other X-ray properties.

By determining the length of the K-wire as described above and by knowing it's thickness the position and orientation of the K-wire regarding the coordinate system of the C-arm can be calculated.

The before mentioned step allows a representation of the position of hollow needle and K-Wire relative to the model of the bone. A further advantage results, by taking X-ray Images from different directions for an automatic adaption of the models.

FIG. 4 shows a solid view of the model according to FIG. 3 with

virtual bone model 4.1;

virtual hollow needle 4.2 and

Tip of the wire 4.3 inserted through the virtual hollow needle 4.2 protruding into the joint.

FIG. 5 depicts a cut view of the model according to FIG. 3 with

virtual bone model 5.1

virtual hollow needle 5.2 and

virtual Wire 5.3.

A second and even a third 3D virtual hollow needle models can be positioned at the ideal place (as chosen by the surgeon) of the virtual bone region, to guide the perfect position of another real needle in the real patient:

FIG. 6 depicts a Second virtual hollow needle in the ideal position cut view with the corresponding elements

virtual bone model 6.1

virtual hollow needle 6.2 and

virtual Wire 6.3.

The software within the computer can be controlled by a remote gyro-mouse by the surgeon, the gyro-mouse being covered with a sterile drape.

Remarkably, the inventive system and method already assist the surgeon during the surgery prior to the steps of the insertion of an object as e.g. a hollow needles into the bone(s) of the patient. Time for the recovery from the bone fracture and the comfort of the patient are increased significantly by the application of the method described above and the system used.

### LIST OF REFERENCE SIGNS, GLOSSARY

1.1 X ray image of real bone
1.2 X ray image of hollow needle
1.3 X ray image of wire inserted inside of hollow needle
2.1 Virtual bone model
2.2 Virtual hollow model
2.3 Virtual wire
3.1 Virtual bone model
3.2 Virtual hollow needle
3.3 Virtual wire
4.1 Virtual bone model
4.2 Virtual hollow needle
4.3 Tip of the wire inserted through the virtual hollow needle 4.2 protruding into the joint.
5.1 Virtual bone model
5.2 Virtual hollow needle
5.3 Virtual Wire
6.1 Virtual bone model
6.2 Virtual hollow needle
6.3 Virtual Wire
7.1 Virtual bone model
7.2 Virtual hollow needle
7.3 Virtual Wire
48 C-arm system
412 C-arm image of a real bone 49
50 object 50
45 image in reproduced simulated radiation mode
41 virtual image of a virtual bone
2D two dimensional
3D three dimensional
CAT computed axial tomography
CT scan,
CAT scan computed axial tomography and body section röntgenography
K-wire wire of Martin Kirschner
MRI magnetic resonance imaging
XRII X-ray image intensifier

### LIST OF CITED DOCUMENTS

[1] DE 10 2006 004 703 A1
   <<Betrieb eines Positionsroboters>>/<<Method for operating a positioning robot especially in medical>>
   MedCom Gesellschaft für medizinische Bildverarbeitng mbH, 64283 DE-Darmstadt; SAKAS, Georgios, 64283 DE-Darmstadt
[2] WO 2006/125605 A1
   <<Needle Positioning System>>
   AMEDO GmbH, DE 44799 Bochum
[3] WO 2009/027088 A1
   <<Augmented visualization in two-dimensional images>>
   ETH Zürich, CH-8092 Zurich
[4] U.S. Pat. No. 7,489,810 B2
   <<Method and system for linking location information between software applications for viewing diagnostic medical images>>
   Assignee: GE Medical Systems Information Technologies, Inc., Milwaukee, Wis. (US)

1-6. (canceled)

7. A method of determining a relative position of a hollow needle with a wire partially held by the hollow needle and a bone of a creature, comprising the following steps:
i) acquiring into a computer an X-ray image of the hollow needle inserted into the creature, with the X-ray image including at least an image of:
the bone of the creature;
the hollow needle; and
the wire inserted inside of the hollow needle into a bone region;
ii) opening a 3D virtual model of the bone region, the bone region including:
a virtual bone model;
a virtual hollow needle; and
a virtual wire;
iii) opening a 3D virtual model of the hollow needle actually used and the wire actually used;
iv) assessing a 3D virtual exact position of the needle and wire actually used with respect to the bone region by freely moving, rotating and zooming the 3D virtual objects.

8. The method according to claim 7, wherein step iv) comprises assessing the 3D virtual exact position either by generating a solid 3D view or by generating a cut view.

9. The method according to claim 7, wherein step iv) comprises determining a geometry of the X-ray image of:
the bone model;
the hollow needle; and
the wire.

10. The method according to claim 9, wherein the wire is a K-wire and a scale mounted on the K-wire, enabling a determination of a length of the K-wire outside of the hollow needle.

11. The method according to claim 10, wherein the scale mounted on the K-wire comprises recesses and/or indents in equidistant intervals allowing a determination of the length of the K-wire outside the hollow needle.

12. The method according to claim 10, wherein the scale mounted on the K-wire comprises specific X-ray markers in equidistant intervals allowing a determination of the length of the K-wire outside the hollow needle.
